(19) United States
(12) Patent Application Publication
(10) Pub. No.: US 2012/0270497 A1
(43) Pub. Date: Oct. 25, 2012

(54) Manipulable Cubes Base Station

(75) Inventors: David Jeffrey Merrill, San Francisco, CA (US); Jeevan James Kalanithi, San Francisco, CA (US); Liam O'Shea Staskawicz, San Francisco, CA (US); Micah Elizabeth Scott, San Francisco, CA (US)

(73) Assignee: SIFTEO, INC., San Francisco, CA (US)

(21) Appl. No.: 13/450,351

(22) Filed: Apr. 18, 2012

Related U.S. Application Data
(60) Provisional application No. 61/477,542, filed on Apr. 20, 2011.

(51) Int. Cl. H04B 5/00

(52) U.S. Cl. 455/41.1

(57) ABSTRACT

A mobile and autonomous base station facilitating wireless electronic games embodying one or more tangible user interface manipulable devices (cubes) is comprised of at least one wireless communication device, a power source, an output device, a memory, and controller/processor. The base station is operable to receive from, and transmit data to plurality of manipulable devices including motion, proximity and arrangement information. In addition the base station includes the ability to sense the proximity and orientation of nearby manipulable devices.

### RELATED APPLICATION

The present application relates to and claims the benefit of priority to U.S. Provisional Patent Application No. 61/477,542 filed 20 Apr. 2011, which is hereby incorporated by reference in its entirety for all purposes as if fully set forth herein. The present application is further related to commonly assigned U.S. patent application Ser. No. 12/909,690 filed 21 Oct. 2010.

### BACKGROUND OF THE INVENTION

1. Field of the Invention

Embodiments of the present invention relate, in general, to embedded systems for human-computer interaction (“HCI”) with interactive physical objects and more particularly to HCI systems in which a base station runs applications that control multiple wirelessly-communicating interactive devices.

2. Relevant Background

A new type of computer interface, developed by Sifteo Incorporated and as described in co-pending U.S. patent application Ser. No. 12/909,690, comprises a collection of small interactive manipulable devices that users physically manipulate by hand. Each one of these manipulable devices or cubes is referred to, as would be known to one or reasonable skill in the art, as a “Sifteo Cube” (also referred to herein as “cube” or “manipulable device”). In the first generation of this interface a collection of cubes communicates wirelessly with another processor or computer, referred to as a “host”, during use to present interactive games and learning tools. Each cube has one or more embedded processors and one or more graphical displays that can be controlled at runtime by a software program running on the host to display dynamic graphical animations and other visual feedback to the user. Each cube further includes adjacency/proximity sensing capability to detect the identity and orientation of cubes placed nearby as well as motion-sensing with a three-axis accelerometer. Each cube further has an internal battery that powers it during use which, in some versions, can be recharged.

Previous implementations of the system utilized a computer host on which the software applications run creating a game state. Information sensed by the cubes about user manipulation of the cubes are conveyed to the host as input, and correspondingly the host controls the interactive displays on the cubes during play using bi-directional wireless communication. As input, these applications make use of the cubes' ability to sense movement (shaken, tilted, flipped), touch (button press) and arrangement (placed next to each other) by the user. As an output, the host controls the graphical display on the cubes and generates sound that is typically emitted by the host. The applications (instructions) are written in a variety of software languages including C# and desktop software on the host runs applications inside a C# runtime embedded inside a program written in C++ and Qt. Different user accounts can have different applications (games) associated with them, and on startup, the desktop software and processing capability resident on the host shows all installed applications for the user account that is currently logged in. Using the desktop software, a user can browse, select, start, pause, and stop applications on the cubes. An application store allows users to browse, buy, and download applications from the Internet to their local system. A single host can be associated with a plurality of user accounts, each possessing different applications.

In the initial instantiation of Sifteo Cubes, the host was a standard (e.g. laptop or desktop) personal computer (PC). The runtime software that controlled games and other applications on the cubes ran on Mac or Windows computers, and communicated wirelessly with the cubes using a USB dongle having a built-in 2.4 GHz radio. Users interacted with the standard PC desktop interface to start the runtime software and to browse, select, start and stop games. Game audio played from the PC speakers, connected speakers, or from headphones plugged into to this host. In addition the runtime software could access the Internet via a host's network connection. The prior systems thus relied on the inherent capabilities of a personal computer. While functional, these prior systems where not without their limitations. One significant disadvantage for users of having cubes controlled by the standard PC is that any play with cubes involved the use of a PC, and thus the portability of the system was limited. Many users of the initial instantiation of Sifteo Cubes expressed a desire for the system to avoid reliance on a PC, in order to make their experience with cubes more portable and convenient. And despite a host's ability to access the Internet using a WiFi or wired connection, PCs do not include access to cellular networks. Yet entirely eliminating the presence of a central processing device and building this control capability directly into the cubes would require either a heterogeneous mix of cubes (e.g. a single “super” cube to control the rest) or the inclusion of cost-prohibitive processing, communicating and memory capability in each cube. Moreover much of the functionality and versatility of the cubes is based on a thin client architecture in which a single processor runs all major application logic. Thus entirely eliminating the host is not technically nor economically feasible. A need therefore exists to increase mobility and network accessibility of manipulable interactive devices such as the Sifteo Cubes without reducing their functionality or versatility while still maintaining an overall thin client architecture. These and other deficiencies of the prior art are addressed by one or more embodiments of the present invention.

### SUMMARY OF THE INVENTION

A mobile and autonomous base station facilitating a wireless electronic game embodying one or more tangible user interface manipulable devices (cubes) is hereafter described. According to one aspect of the present invention a base station comprises at least one wireless communication device, a power source, an output device, a memory, and controller/processor. In one embodiment of the present invention the wireless communication device is operable to receive from, and transmit data to, a plurality of tangible user interface manipulable devices. This bi-directional data can include motion, proximity and arrangement information as well as behavior commands and/or digital content.

The memory of the base station is, in one embodiment adapted to include a plurality of instructions as well as other digital content. These instructions include directives to wirelessly control behavior and rendering of imagery on the tangible user interface manipulable devices as well as instructions to select an application and create a game state. The base station memory can also store instructions to facilitate interaction with cellular devices, other base stations or communicate directly with the Internet. The controller/processor of the base station is operable to receive, via the communication device, and process data from the manipulable devices as well as other sources. The controller/processor accordingly executes instructions stored on the base station to not only control the behavior of the tangible user interface manipulable devices but also to create and manage, in one embodiment of the present invention, a game state. The game state combined with data relating to position and movement of the manipulable devices results in new commands and digital content to be rendered by the manipulable devices. The base station further possesses an output device such as a speaker that can generate appropriate output based on the game state and one or more user interfaces such as a home or reset button.

In another embodiment of the present invention the base station includes an internal proximity sensor that provides data to the controller/processor regarding the base station's position and motion relative to the one or more manipulable devices. This additional information can be used to adjust the game state and/or the commands and digital content directed to the manipulable devices as well to pair manipulable devices to the base station. In another embodiment the communication device can include the means to establish cellular or similar wireless communication with another device such as a cell phone or WiFi network.

A method for user interaction with digital content using the base station and one or more manipulable devices is another aspect of the present invention. This method embodiment includes storing, at the base station, digital content and a plurality of instructions, pairing the manipulable devices to the base station, receiving from the manipulable devices data with respect to proximity and arrangement, forming a game state, and with a game state established issuing secondary commands and/or sending digital content to the manipulable devices regarding the rendering of imagery.

The code stored on the base station can include code to manage behavior of one or more tangible user interface manipulable devices as well as the operation of the base station itself. The method further pairs one or more tangible user interface manipulable devices to the distributed tangible user interface base station using a variety of techniques. This pairing can be done, according to one embodiment of the present invention, by bringing a manipulable device within a predefined proximity of the base station. In another embodiment executing a predefined gesture with the manipulable device can pair that device to a base station while in another embodiment pairing can be accomplished by bringing a manipulable device into physical contact with the base station.

Once paired, data regarding proximity, user input and relative arrangement realized at the one or more tangible user interface manipulable devices is sent to and received by the base station. Digital content and instructions in one embodiment of the present invention is managed based on data received from the manipulable devices and the ongoing game state. Finally appropriate digital content and commands are sent to one or more tangible user interface manipulable devices directing the manipulable device's behavior and conveying the game state to the user.

In another embodiment, the present invention provides a system for operating a game in a wireless environment in which a base station stores and processes digital content and instructions creating a game state that is presented to a user via one or more tangible user interface manipulable devices. Each tangible user interface manipulable device is paired to, and wirelessly communicates with, the base station. Through that communication link each tangible user interface manipulable device sends data to the base station regarding its proximity to the base station and/or other manipulable devices as well as the manipulable devices motion and relative arrangement. The base station, using the data received from each of the tangible user interface manipulable devices along with the game state running on the base station, manages digital content and instructions to be responsively sent to each manipulable device. The base station thereafter sends commands and/or digital content to each tangible user interface manipulable device controlling directing what image is rendered on which manipulable device's display to present the current game state to the user.

In other embodiments of the present invention the base station is operable to establish a communication link with a second device such as a host computer and/or cellular device. Using that device new instructions can be stored on the base station for later execution. Alternatively, instructions or applications running on the second device/host can be conveyed to the tangible user interface manipulable devices via the base station, thus using the base station as a mere conduit for commands and digital content. Alternately, instructions or applications running on the base station can utilize the second device/host as an additional display or interactive element. The communication link can also be used to establish an interface with a wide area network such as the Internet. In such an instance one base station can link with other base stations creating a network gaming state. In the case of network play, information based on each base station's game state can be relayed to the other base station which controls the other tangible user interface manipulable devices creating a network game state in which multiple users can interact.

In other embodiments of the present invention the base station can include an internal proximity sensor and can directly interact with the tangible user interface manipulable devices and become part of the game state. Moreover if the base station links with a device having locational or geospatial capabilities that device and its information regarding geospatial location can also be included in the game state thus expanding the user interface experience.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a wireless environment in which the base station, according to one embodiment of the present, invention is implemented;

FIG. 2 shows a high level block of a tangible user interface manipulable device base station, according to one embodiment of the present invention; and

FIG. 3 is a flowchart of a method embodiment for controlling tangible user interface manipulable devices using a base station of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

A mobile and autonomous base station communicatively coupled to a plurality of tangible user interface manipulable devices is hereafter described by way of example. A distributed tangible user interface base station, also referred to herein as a base station or control station, interacts with and is communicatively coupled to a plurality of tangible user interface manipulable devices. These tangible user interface manipulable devices, also referred to as “manipulable cubes” or simply “cubes,” act as a user interface for a game state running, in one embodiment, on the base station.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Included in the description are flowcharts depicting examples of the methodology which may be used to manage and control one or more tangible user interface manipulable devices. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the device or other programmable apparatus create means for implementing the functions specified in the flowchart block or blocks. These program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Unless specifically stated otherwise, discussions herein using words such as “processing,” “controlling,” “directing,” “determining,” “presenting,” “displaying,” or the like may refer to actions or processes of a machine (e.g., a computer or base station) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. The terms “comprises,” “comprising,” “includes,” “including,” “has,” “having” or any other variation thereof, as used herein are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Upon reading this disclosure, those of reasonable skill in the relevant art will appreciate still additional alternative structural and functional designs for a base station for interacting with one or more tangible user interfaces (cubes) through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

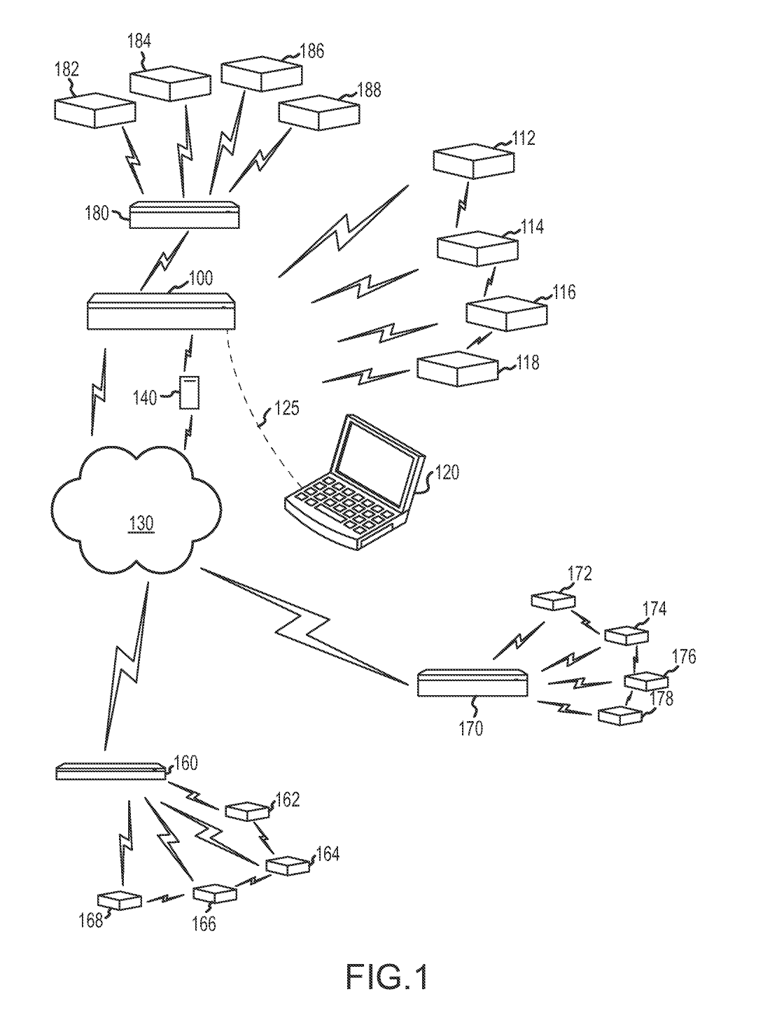

FIG. 1 shows a wireless environment in which a distributed tangible user interface base station, according to one embodiment of the present invention, interacts and interfaces with a plurality of tangible user interface manipulable devices. As shown, the base station 100 wirelessly communicates with one or more manipulable device 112, 114, 116, 118. Moreover, the manipulable devices can, in a limited capacity, communicate with each other.

In one version of the present invention the base station 100 also includes the means by which to communicate and interface with a wide area network 130 such as the Internet. For example, the base station 100 can include wireless communicative capabilities to interact with a cellular phone 140 or personal data assistant, or the like that can then in turn link the base station 100 with the Internet. In alternate embodiments the base station can directly possess cellular or wireless Internet capability to interact directly with the wide area network or the Internet.

Also, as shown in FIG. 1, the base station 100 can be communicatively linked either wirelessly or by hardware, such as via a USB port, to a computer or host computing device 120.

When the base station 100 is linked to a wide area network 130 such as the Internet it can further be in communication with other base stations 160, 170 which in turn can be in communication with a plurality of other tangible user interface manipulable devices 162, 164, 166, 172, 174, 176, 178. In another embodiment a base station 100 can communicate directly with another base station 180 which then in-turn can communicate with other tangible user interface manipulable devices, 182, 184, 186, 188.

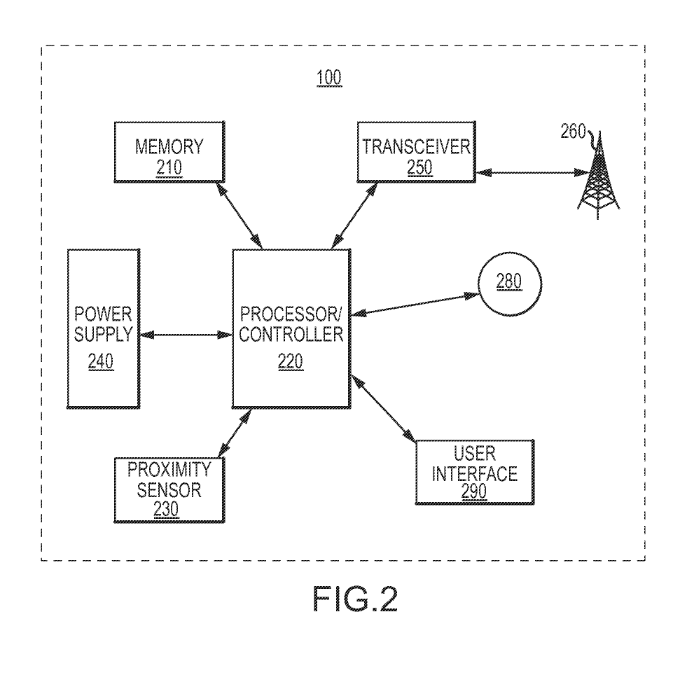

Turning attention in addition to FIG. 2, a high level architecture in the form of a block diagram of the base station 100 is shown. According to one embodiment of the present invention, the base station 100 includes a memory 210, a processor/controller 220, a proximity sensor 230, a power supply or source of power 240, one or more radio transceivers 250 which is in-turn coupled to an antenna 260, an output device such as a speaker 280, and a user interface 290. And in an alternate embodiment the base station 100 can include an additional communication device having the means for the base station 100 to directly communicate with a wide area network such as the Internet via a cellular modem or Wi-Fi connection. In one embodiment this additional communication capability can reside in the transceiver or in another embodiment be a separate component. The dual communication capability can include a 2.4 GHz radio in addition to a Bluetooth radio or a single radio that is operable to receive and transmit on 2.4 GHz and on Bluetooth. Indeed multiple combinations and permutations of a single radio and or multiple radios capable of receiving and transmitting on Bluetooth, WiFi, 2.4 GHz radios and the like are contemplated as being implementable as part of the present invention.

The embedded processor/controller 220 of the present invention is operable to execute instructions in the form of binary code stored on the memory 210. As one of reasonable skill in the relevant art will appreciate the processor/controller 220 can be of various designs and specifications so as to meet the requirements outlined herein. Similarly, the memory 210 can be comprised of both random access memory RAM and nonvolatile data storage capable of storing a plurality of instructions which may take the form of program codes or game applications to be run on the processor/controller 220 at runtime. Moreover instructions regarding the operation of the base station itself as it interacts with and is paired to the manipulable devices can be stored in the memory as well as instructions regarding game selection and interaction with other devices such as a cellular phone.

In a preferred embodiment the nonvolatile memory is flash memory or solid-state and the applications that create the game state are comprised of code, images in the form of digital content and sampled audio fragments with instructions operable to create audio signals for the output device.

These gaming applications are transferred to the base station 100 via, in one embodiment, a USB port that connects the base station 100 to a computer or host device and are thereafter stored on the internal memory 210. Using the host device or similar computer the user can select and download from the Internet one or more game applications which then can be transferred to the base station 100 for later execution. The host device which can take the form of a desktop, laptop, netbook, tablet computer, or smartphone, interfaces the user with the Internet and an application store at which a variety of gaming applications can be selected.

The download of applications to the base station 100 can also occur via a cellular network communication or any other viable link to the Internet thus bypassing the direct need for a host computer interaction. Moreover and in an additional embodiment of the present invention, an internal cellular or Wi-Fi capability in the base station can direct the base station to wirelessly synchronize with an established account in which any available purchased applications are automatically downloaded and stored on the base station for later use. Yet another embodiment enables a user to transfer applications to the base station using a flash or thumb drive or similar media which can connect directly to the base station. Once an application is downloaded and stored on the base station the application is available for immediate execution by the internal processor/controller and the associated manipulable devices.

The power source 240, in one embodiment, is a battery coupled to and operable to power the processor/controller 220 and, if necessary, maintain data in the memory 210 and power other components of the base station. In an alternative embodiment the battery may be rechargeable and the base station 100 include recharging circuitry to enable battery recharging without its removal from the base station. In addition and in an alternative embodiment the base station 100 may include circuitry and a power receptacle by which the base station 100 may be powered through a direct connection to a standard electrical outlet or USB port. Ideally the internal power source 240 of the base station 100 will enable the base station to operate for a significant amount of time independent of any other power supply. For instance, if the manipulable devices have a battery life of 4 hours the base station should accordingly be able to process and instruct the operation of the manipulable devices for 6 to 8 hours. In one version of the present invention a visual indication of the battery level life remaining is presented on the base station exterior. For example three LEDs may indicate a good, low, and exhausted capability. Alternatively a single LED having a plurality of colors such as green yellow and red can be used divulging the same intuitive information regarding battery life. To preserve battery life and to maintain the operation of the base station the processor/controller 220 monitors the activity of the manipulable devices and after a predetermined period of inactivity places the base station and the manipulable devices into a sleep mode or turns them off completely thereby preserving battery life.

The base station 100 and the manipulable devices possess an internal and self-contained power supply aiding in their autonomy. In an embodiment in which the power supply or battery is both permanent and/or rechargeable the base station may provide a means by which to recharge not only its internal power supply but also those of the manipulable devices. In such an embodiment the manipulable devices are placed into receptacles present in the design of the base station which possess electrical contacts and thus convey power to recharge each device's internal battery. The same contacts can enable the transfer of digital content and if necessary instructions to the internal memory located in each manipulable device.

The base station 100 of the present invention further includes one or more user interfaces 290 which can take the form of a button or similar device which enables discrete user interaction with the base station 100. In addition the base station can include an on/off switch and a simple power display to indicate that the base station is powered as well as the state of its battery life.

The base station 100 also includes an output device 280 such as an audio speaker. In one version of the present invention an amplifier is coupled to the processor/controller 220 that is in turn linked to a speaker amplifier and/or a headphone jack. In addition, the base station 100 can include a volume control such as a slider control interface which will allow the user to manipulate the volume of the speaker and/or headphone jack.

The transceiver radio 250 of the base station 100 is primarily designed to establish and maintain a communication link with each manipulable device. According to one embodiment of the present invention this transceiver radio communicates with the manipulable devices at 2.4 GHz frequency using a custom protocol. As one skilled in the relevant art will appreciate other forms of radio communication, bluetooth for example, can be utilized to interface with the manipulable devices.

As previously discussed an additional communication device can also be incorporated into the base station 100. This additional communication device can, in one embodiment of the present invention, communicate with a cellular device such as a cell phone, tablet, personal data assistant, or any other device operable to communicate on a network of choice. By doing so the base station 100 can interface with a local or wide area network such as the Internet. In addition, as described hereafter, a cellular device linked to the base station via the additional communication device can be integrated into the game state as an additional display or supplemental manipulable device. Users can interact with phone much like a cube enhancing the user experience. Moreover, if the cellular device includes any geospatial or location capabilities such as a GPS receiver that information can be conveyed and used by the base station to modify and manage the game state and thus the interface of the manipulable devices presented to a user. As one of reasonable skill in the art will appreciate other devices that are not technically cellular can also, in other embodiments of the present invention, interface with the base station. Integration with devices such as an iPod Touch, iPad, or a WiFi device are contemplated.

An additional feature of the base station 100 is a proximity sensor 230 that provides to the base station the ability to sense and determine its orientation, position with respect to a plurality of manipulable devices. The proximity sensor in one embodiment of the present invention incorporates the same technology utilized by the manipulable devices to sense proximity and orientation. For example, the proximity sensor of the base station can detect electromagnetic fields generated by each manipulable device. As particular patterns of fields of electromagnetic radiation interact that signatory interaction can be detected and processed by the base station to determine the proximity and identity of the manipulable device with respect to the station. As one of reasonable skill in the relevant art will appreciate other means by which to determine location, movement and/or proximity can be implemented and are contemplated by the present invention. By providing the base station 100 with proximity, relational and orientation information with respect one or more manipulable device, the base station can become an integrated member of the game interaction and state. And while it does not, in a preferred environment, possess a display device it nonetheless enhances the gaming environment and the user experience.

For the base station and one or more manipulable devices to form the system and act as a tangible user interface, each capable device must be uniquely paired or associated with the base station. Utilizing the capabilities of the base station and those in each manipulable device the pairing process can be accomplished by a single user interaction. For example, according to one embodiment of the present invention, a manipulable device can be paired to a particular a station by simply bringing that manipulable device within a predefined proximity of the base station. Using the proximity sensor incorporated in the base station and the proximity sensor incorporated into the manipulable device, instructions resident on the base station can interpret the close interaction between the manipulable device and the base station as a desire to establish an association. Once an association or pairing has occurred data reflective of that pairing can be stored in the nonvolatile memory of the base station and retained for later use. Accordingly a manipulable device need only be paired to a particular base station once.

According to another version of the present invention a manipulable device can be paired to the base station by bringing a manipulable device and a station into physical contact. For example a manipulable device can be paired to the base station when a particular corner or side of the manipulable device touches a particular corner or side of the base station. This can be accomplished not only by the proximity of the two devices with respect to each other but also their orientation and sense of movement so as to determine which portion of the manipulable device is in proximity with which portion of the base station and when contact actually occurs. For example an accelerometer can register a distinct deceleration when the two devices come into contact.

Similarly, a manipulable device can be paired to a base station by the manipulable device performing a predetermined gesture or movement device within a certain proximity of the base station. For example a manipulable device can be paired to a particular base station by bringing the manipulable device within a certain range of the base station and tilting, rotating or shaking the manipulable device in such a manner that is changing orientation uniquely identifying it to the base station. In each embodiment with respect to pairing a manipulable device to a particular base station the instructions necessary to accomplish the pairing resides in the memory of the base station and is executed by the processor/controller. Accordingly the pairing of manipulable devices to a particular base station is independent with respect to a host or any additional device. Moreover it can be, as illustrated above, a singular motion without any additional input, such as inputing a pairing code, from the user. Manipulable devices that are not associated with or paired with a particular a station will not wirelessly communicate with that base station even if they are within its wireless range. Once a manipulable device is paired to a particular base station the base station can download or pre-load particular portions of digital content and/or instructions to the manipulable device. By doing so later execution of gaming applications can operate more efficiently with respect to the rendering of images or displays on the manipulable devices. In addition the processor/controller located on the base station can prescreen instructions and/or applications resident on the base station to determine which portions of digital content and/or instructions can be preloaded to manipulable devices.

With applications and digital content downloaded and stored in the memory of the base station, and with one or more manipulable devices paired to the base station, the base and its paired manipulable devices are ready to establish the game state and provide a user manipulable interface.

The base station and the manipulable devices remain in a off or sleep mode until there is direct interaction with the base station and/or one or more manipulable devices by a user. Upon the occurrence of any interaction with the base station and/or manipulable devices, both enter a fully on state and await further instructions with respect to what application or gaming state is to be established. According to one embodiment the present invention the base station can awake from a dormant state by a user pressing the home button or cycling the on/off switch from off to on. Similarly the base station and paired manipulable devices can be awakened by users touching one or more manipulable devices or performing a certain gesture. Once awakened, the base station and each paired manipulable device becomes fully operational replacing a host with respect to the selection and execution of a gaming application.

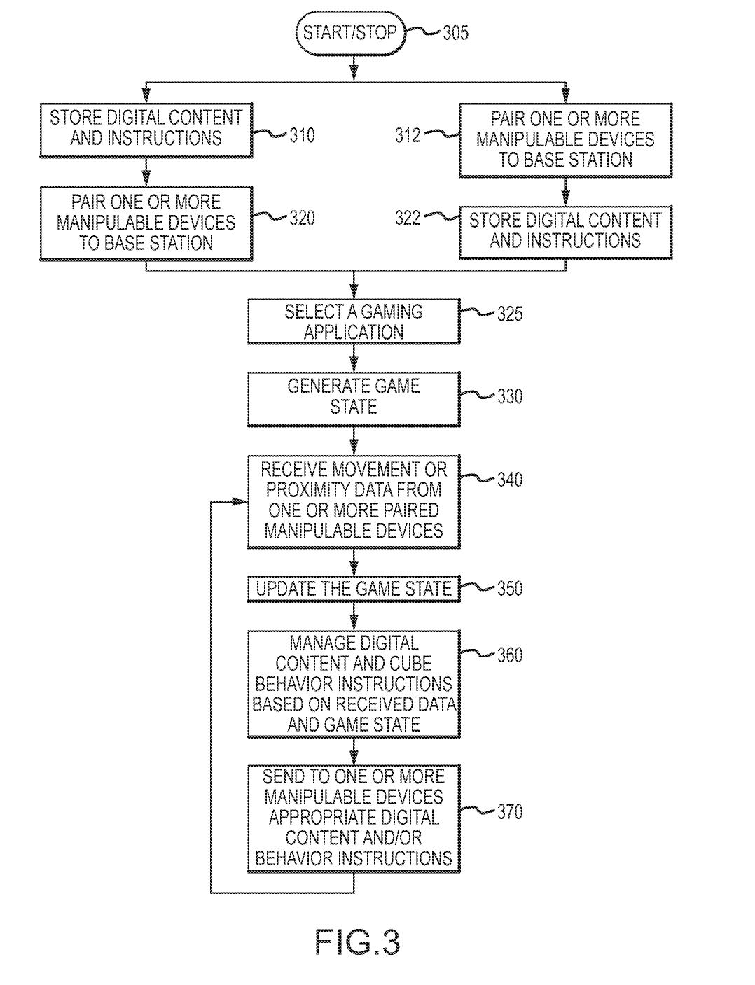

One method embodiment for user interaction with digital content using manipulable devices and a base station, is shown in FIG. 3. The process begins 305 with storing 310 digital content and a plurality of instructions, representing both commands and gaming applications, in nonvolatile memory on a base station. Once the content and application instructions are stored and one or more manipulable devices are paired 320 with the base station, the base station and the pair manipulable devices can present to the user a selection of the available games. In other embodiments of the present invention manipulable devices can be paired 312 to a particular base station prior to the storing 322 of digital content.

Through a variety of techniques described below the user can interact with the manipulable devices and/or base station to select 235 an application of choice and the processor/controller can establish a game state 330 based on one of the stored game applications. In one embodiment of the present invention upon awakening from a sleep state each of the paired manipulable devices shows a title screen of a different installed application resident on the base station. An application of choice can be selected, in one embodiment, by the user touching the screen of the cube displaying the desired application. Tilting any of the paired cubes can result in the application titles presented on each cube advancing by one item. In this way each of the stored applications resident on the base station can be displayed on the manipulable devices and offered for user selection. In an alternative embodiment the display screen of one manipulable device can display a button while the other cubes can display a title screen of a different application. Pressing on the button advances the title screens by one item while pressing on the screen of the cube showing the desired application selects that application. In an alternative embodiment the display screen of one manipulable device displays a single game title screen, with slivers of other title screens at the left and right edge of the display. Tilting the manipulative device to the left or right causes the game title screen in the appropriate direction to slide into view as if all title screens for installed games were part of a single strip that responds to gravity. Touching the screen of the cube displaying the desired application causes the selected game to start. In yet another embodiment the base station includes a touch strip in which a finger swipe on the strip advances the applications displayed on the manipulable devices. In other embodiments the base station can include multiple user interfaces which can be used to display and select an appropriate game. One of reasonable skill in the relevant art will appreciate that a variety of interactions between the base station and manipulable devices can be established so as to present to user each of the stored applications resident on the base station.

A game state 330 is thereafter established on the base station by the instantiation of one of the stored applications and an initial orientation/arrangement data of each paired manipulable device. A running game or game state can also be interrupted or paused by a user pressing the home button on the base station. By pressing the button on the base station a second time the user stops the game state and returns the base station and manipulable devices to an application selection mode.

One of reasonable skill in the relevant art will appreciate that the base station in conjunction with one or more manipulable devices present a user an interface by which the user can review and select an application resident on the base station. The displays on one or more of the manipulable devices can also be used to reflect the paused state of the game and thereafter user interaction can be used to determine whether the game is to continue or whether the system is to reenter the application-selection mode and ultimately sleep/off mode.

Once a game state is established each manipulable device communicates “change of state” data to the base station. This data is reflective of movement, touch, proximity and arrangement information. As has been described herein the base station determines, based on information gained from the cubes, cube arrangement and motion. The base station can then determine one cube's motion, orientation, or position relative to another cube's position or motion. This relational information/data assists in determining the game state. In addition the base station itself can sense the proximity and arrangement of the cubes with respect to its location and use this information to supplement the relational data.

The base station, upon receipt 340 of information from the one or more manipulable devices, modifies the game state 350. The changed game state is reflected to the user through the changing graphics on the displays of the manipulable devices. Accordingly the base station manages digital content and/or instructions to modify behavior of the one or more manipulable devices 360. The revised digital content and/or behavior instructions are sent 370 to the appropriate manipulable devices which present the new game state to the user. With the new game state presented the user interfaces with the manipulable devices to begin the process anew.

The wireless control of the manipulable devices by the base station gives an application the ability to control what is displayed on each individual manipulable device, as well as to configure the state of a manipulable device's internal runtime. It also permits the running application to be notified of a user-initiated events on each device, such as touching the screen, physical adjacency of one manipulable device to another manipulable device, or inertial events of the manipulable device such as shaking, tilting, or moving the manipulable device upside down. While a user interacts with the manipulable devices and the application is being run on the base station, the output device on the base station provides an audio feedback based on the game state. As previously described the audio is played through a speaker incorporated into the base station or via headphones. In another embodiment a Bluetooth radio would allow the audio to be streamed wirelessly to wireless headphones, a users mobile device for amplification, or users home audio system.

The game state can also be modified with the addition of a cellular device or host. The interaction between the base station and the manipulable devices regarding the selection of the gaming application remains the same but the base station can direct the application to be run on a host computer or a linked cellular device rather than on the base station itself thus enhancing processing capability and persevering battery life. In such an instance the base station acts as a conduit of information from the host to the manipulable devices. In this configuration the game audio could optionally be played by the host computer or linked cellular device. This device can be wirelessly associated with the base station or possess a hardwired connection via a USB port.

The present invention provides a base station for use with plurality of tangible user interface manipulable devices. The base station includes among other things memory to store a variety of gaming applications, behavior instructions and digital content, and a processor to eliminate the need of a host computer. Through the use of the base station the user can interface with a gaming application using only the manipulable devices. Game selection, initiation, and termination are substantially accomplished by interacting with the manipulable devices rather than a host computer. While the base station does possess minimal user interface capabilities its primary function is to facilitate the a user's interface with the manipulable devices.

To better understand the present invention consider the following example. Assume a user has established an account and purchased 5 unique gaming applications using a software application on their host computer. Before the user can initiate the applications on the base station and use the manipulable devices these 5 purchased applications must be downloaded and stored on the base station. The downloading and/or storing can take place wirelessly or via a USB connection to their host computer. Once the applications have been downloaded the base station and the manipulable devices can present the available applications to the user for selection.

With the 5 applications downloaded onto the base station the user first awakens the base station, according to one embodiment, by pressing a home or on/off button located on the base station. If any manipulable devices had been previously paired to that particular base station, and they are within a predefined proximity of at the station, they too will awaken upon the base stations initiation. If additional manipulable devices need to be paired to the base station the user can do so using the techniques described above.

Once awoken the base station will direct the manipulable devices to display the available stored applications for user selection. Using one or more techniques the user selects a desired application. Once selected the base station instantiates the game and begins to collect data from the manipulable devices. Digital instructions and content reflecting the game state is transmitted from the base station to the manipulable devices and proximity and orientation information is transmitted from the manipulable devices back to the base station. As the user interacts and manipulates the manipulable devices additional data is transmitted from each manipulable device to the base station which responsively uses that information to alter the game state and supply new digital content and behavior instructions to the manipulable devices.

The game state and user interaction continues until the game terminates at which point the base station again reenters the selection mode in which a user can select a new game or reinitiate the same game on the manipulable devices. Upon inaction for a predetermined period-of-time the base station and manipulable devices enter sleep/off mode to preserve battery life.

As the base station possesses a proximity sensor the base station itself can be incorporated into the game state. For example a maze or game based on the orientation and position of the manipulable devices can be structured around the base station. Moreover, if the base station is in communication with a cellular device and a cellular device can provide positional awareness it too can become part of the game state and incorporated into the game.

The base station increases the mobility and autonomy of the manipulable devices without reducing their capability. By utilizing the display and inherent capability of each manipulable devices along with the proximity sensors inherent in the base station the present invention can provide the user with the ability to play interactive games using a plurality of manipulable devices without being tied to a PC or similar computer.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

As will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A distributed tangible user interface base station, comprising:
at least one wireless communication device, the wireless communication device operable for receiving data from and transmitting behavior commands and/or digital content to one or more tangible user interface manipulable devices;
a power source;
an output device;
a memory adapted to store a plurality of instructions including instructions to wirelessly control rendering of an image on the one or more tangible user interface manipulable devices;
at least one proximity sensor; and
at least one controller operable for:
executing the one or more instructions;
receiving data from the at least one proximity sensor and/or the at least one of the one or more tangible user interface manipulable devices; and
processing the received data to derive movement and proximity parameters.

2. The distributed tangible user interface base station of claim 1, wherein the controller is operable for pairing a new tangible user interface manipulable device to the distributed tangible user interface base station responsive solely to determining that the new tangible user interface manipulable device and the distributed tangible user interface base station have preformed a predefined gesture within a predefined proximity.

3. The distributed tangible user interface base station of claim 1, wherein the controller is operable for pairing a new tangible user interface manipulable device to the distributed tangible user interface base station responsive to solely bringing the new tangible user interface manipulable device into physical contact with the distributed tangible user interface base station.

4. The distributed tangible user interface base station of claim 1, wherein the controller is operable for pairing a new tangible user interface manipulable device to the distributed tangible user interface base station responsive to solely determining that the new tangible user interface manipulable device is within a predefined proximity of the distributed tangible user interface base station.

5. The distributed tangible user interface base station of claim 1, wherein the controller is operable for generating sounds based on the instructions that manage behavior of one or more tangible user interface manipulable devices and data received from the one or more tangible user interface manipulable devices.

6. The distributed tangible user interface base station of claim 1, wherein the controller is operable for determining a relational arrangement of the one or more tangible user interface manipulable devices.

7. The distributed tangible user interface base station of claim 1, wherein the at least one controller pre-screens the plurality of instructions for optimized performance at runtime.

8. The distributed tangible user interface base station of claim 1, wherein the at least one proximity sensor can sense the proximity and orientation of another distributed tangible user interface base station.

9. The distributed tangible user interface base station of claim 1, wherein the at least one proximity sensor can sense the proximity and orientation of the one or more tangible user interface manipulable devices.

10. The distributed tangible user interface base station of claim 1, wherein the controller is operable to process and/or sense elevation data.

11. The distributed tangible user interface base station of claim 1, wherein the controller is operable to process and/or sense geospatial data.

12. The distributed tangible user interface base station of claim 1, wherein the one or more instructions are synchronized with instructions residing on a host computer.

13. The distributed tangible user interface base station of claim 12, wherein the one or more instructions are synchronized wirelessly.

14. The distributed tangible user interface base station of claim 13, wherein the one or more instructions are synchronized wirelessly via a cellular network

15. The distributed tangible user interface base station of claim 1, wherein proximity parameters includes parameters between one or more tangible user interface manipulable devices and/or between the one or more tangible user interface manipulable devices and the distributed tangible user interface base station.

16. The distributed tangible user interface base station of claim 1, wherein movement parameters includes parameters about one or more tangible user interface manipulable devices.

17. The distributed tangible user interface base station of claim 1, wherein the plurality of instructions includes instructions to manage behavior of one or more tangible user interface manipulable devices.

18. The distributed tangible user interface base station of claim 1, wherein the at least one wireless communication device is operable to communicate with a cellular device.

19. A method for user interaction with digital content, the method comprising the steps of:
storing at a distributed tangible user interface base station digital content and a plurality of instructions including one or more instructions to manage behavior of one or more tangible user interface manipulable devices;
pairing the one or more tangible user interface manipulable devices to the distributed tangible user interface base station;
receiving from the one or more tangible user interface manipulable devices data regarding movement and/or positional orientation between two or more of the paired tangible user interface manipulable devices;
generating a game state at the distributed tangible user interface base station;
managing the digital content and/or the plurality of instructions based on received data from the one or more tangible user interface manipulable devices; and
sending to at least one of the one or more tangible user interface manipulable devices appropriate digital content and/or behavior instructions based on the received data regarding movement and/or positional orientation between two or more of the paired tangible user interface manipulable devices.

20. The method of claim 19 further comprising detecting a locational based relationship between on or more of the user interface manipulable devices and the distributed tangible user interface base station.

21. The method of claim 19 further comprising generating one or more audible signals based on the managed digital content and/or one or more instructions.

22. The method of claim 19 wherein pairing is solely based on proximity of the distributed tangible user interface base station to the one or more tangible user interface manipulable devices.

23. The method of claim 19 wherein pairing occurs by solely performing one or more predefined gestures by the one or more tangible user interface manipulable devices within a predefined proximity of the distributed tangible user interface base station.

24. The method of claim 19 further comprising receiving data indicative of proximity among the one or more tangible user interface manipulable devices and the distributed tangible user interface base station.

25. The method of claim 19 further comprising accessing the digital content and/or instructions based on data received from the one or more tangible user interface manipulable devices.

26. The method of claim 19 wherein managing the digital content and/or instructions includes accessing the digital content and/or behavior instructions based on interaction between the one or more tangible user interface manipulable devices and the distributed tangible user interface base station.

27. The method of claim 26 wherein the accessed digital content and/or instructions includes geospatial data.

28. The method of claim 26 wherein the accessed digital content and/or instructions includes elevation data.

29. The method of claim 19 further comprising establishing a communication link between the distributed tangible user interface base station and a second device.

30. The method of claim 29 further comprising providing wide area network access to the distributed tangible user interface base station through the second device.

31. The method of claim 30 receiving from the second device digital content from one or more other distributed tangible user interface base stations.

32. The method of claim 31 wherein managing the digital content and/or the plurality of instructions for the paired tangible user interface manipulable devices is based on, in part, by received digital content relationship information between the one or more other distributed tangible user interface base stations and the game state.

33. The method of claim 29 wherein the distributed tangible user interface base station can synchronize the digital content and the one or more instructions with digital content and instructions at a second location via the second device.

34. The method of claim 29 wherein the distributed tangible user interface base station can synchronize the digital content and the one or more instructions with digital content and instructions resident on the second device.

35. The method of claim 29 wherein the one or more instructions to manage behavior of one or more tangible user interface manipulable devices are executed on the second device and conveyed to the one or more tangible user interface manipulable devices via the distributed tangible user interface base station.

36. The method of claim 29 wherein the second device is a cellular device.

37. The method of claim 29 wherein the second device is a host computer.

38. The method of claim 19 wherein managing includes executing the instructions to manage behavior of one or more tangible user interface manipulable devices.

39. A tangible user interface manipulable device control station, comprising:
a wireless communication device;
a proximity sensor operable to detect proximity and relational data between the tangible user interface manipulable device control station and one or more tangible user interface manipulable devices;
an audible signal generator;
a processor; and
a memory operable to store digital content and/or one or more instructions executable on the processor to wirelessly manage and control rendering of an image on the one or more tangible user interface manipulable devices based on proximity and relational data.

40. The tangible user interface manipulable device control station of claim 39 wherein the wireless communication device is operable to communicate with a cellular device.

41. The tangible user interface manipulable device control station of claim 40 wherein proximity and relational data includes geospatial data received from the cellular device.

42. The tangible user interface manipulable device control station of claim 41 wherein the one or more instructions to manage and control rendering on the one or more tangible user interface manipulable devices is based, in part, on proximity and relational data between the cellular device, the tangible user interface manipulable device control station, and the one or more user interface manipulable devices.

43. The tangible user interface manipulable device control station of claim 40 wherein the digital content and/or one or more instructions stored in the memory can be synchronized with a second memory through the cellular device.

44. The tangible user interface manipulable device control station of claim 40 wherein the tangible user interface manipulable device control station can access a wide area network via the cellular device.

45. The tangible user interface manipulable device control station of claim 44 wherein the tangible user interface manipulable device control station can share managed locational relational data to another tangible user interface manipulable device control station via the cellular device.

46. The tangible user interface manipulable device control station of claim 44 wherein the tangible user interface manipulable device control station can share digital content and/or the one or more instructions to another tangible user interface manipulable device control station via the cellular device.

47. The tangible user interface manipulable device control station of claim 39 wherein the one or more tangible user interface manipulable devices can be uniquely associated with the tangible user interface manipulable device control station by determining with the proximity sensor that the one or more tangible user interface manipulable devices is within a predetermined distance of the tangible user interface manipulable device control station.

48. The tangible user interface manipulable device control station of claim 39 wherein the one or more tangible user interface manipulable devices can be uniquely associated with the tangible user interface manipulable device control station by detecting a predetermined motion of the one or more tangible user interface manipulable devices within a predetermined distance of the tangible user interface manipulable device control station

49. The tangible user interface manipulable device control station of claim 39 wherein proximity and relational data includes proximity and relationship data received from the one or more tangible user interface manipulable devices.

50. The tangible user interface manipulable device control station of claim 39 wherein proximity and relational data includes proximity and relationship data between the tangible user interface manipulable device control station and one or more tangible user interface manipulable devices.
